(19) United States
(12) Patent Application Publication
(10) Pub. No.: US 2022/0207564 A1
(43) Pub. Date: Jun. 30, 2022

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Jun HIOKI, Nagakute-shi (JP); Hideo HASEGAWA, Nagoya-shi (JP); Shintaro OSAKI, Handa-shi (JP); Hiroaki SASAKI, Nagoya-shi (JP); Yoshihiro UI, Nagoya-shi (JP)

(73) Assignee: TOYOTA JIDOSHA KABUSHIKI KAISHA, Toyota-shi (JP)

(21) Appl. No.: 17/521,234

(22) Filed: Nov. 8, 2021

(30) Foreign Application Priority Data
Dec. 25, 2020 (JP) 2020-217709

(51) Int. Cl. G06Q 30/02

(52) U.S. Cl. CPC G06Q 30/0261; G06Q 30/0266

(57) ABSTRACT

A control unit in an information processing device acquires a plurality of pieces of information related to a desired facility designated by a user. The control unit in the information processing device also acquires a means of transportation that is used by user to move to the desired facility. The control unit also determines, based on the means of transportation, a piece of information to be preferentially displayed on a terminal associated with the user out of the pieces of information.

### CROSS-REFERENCE TO RELATED APPLICATION

This application claims priority to Japanese Patent Application No. 2020-217709 filed on Dec. 25, 2020, incorporated herein by reference in its entirety.

### BACKGROUND

### 1. Technical Field

The present disclosure relates to information processing devices, information processing methods, and non-transitory storage media.

### 2. Description of Related Art

A navigation system disclosed in Japanese Unexamined Patent Application Publication No. 2011-203026 (JP 2011-203026 A) is a device having at least a function to receive terrestrial digital television broadcasting. The navigation system disclosed in JP 2011-203026 A extracts text data that can identify a facility and its location on map data from video contents of the terrestrial digital television broadcasting. The navigation system displays the text data and image data on which the text data is based in association with a corresponding location on the map data on a display, based on the extracted text data.

### SUMMARY

The present disclosure provides information in a way that is more convenient to a user.

An information processing device according to a first aspect of the present disclosure includes a control unit. The control unit is configured to execute acquiring a plurality of pieces of information related to a desired facility designated by a user, acquiring a means of transportation that is used by the user to move to the desired facility, and determining, based on the means of transportation, a piece of information to be preferentially displayed on a terminal associated with the user out of the pieces of information.

In the above information processing device, the control unit may be configured to determine, based on the means of transportation, an order of priority in which the pieces of information are displayed on the terminal.

In the above information processing device, the control unit may be configured to select a piece of information to be displayed on the terminal from the pieces of information based on the means of transportation.

In the above information processing device, the control unit may be configured to estimate the means of transportation based on information detected by a sensor provided in the terminal.

In the above information processing device, the control unit may be configured to acquire the means of transportation based on information on the means of transportation entered by the user to the terminal.

In the above information processing device, the control unit may be configured to estimate the means of transportation based on a location of the desired facility.

In the above information processing device, the control unit may be configured to estimate the means of transportation based further on a travel history of the user.

In the above information processing device, the control unit may be configured to determine information on a parking lot associated with the desired facility to be the piece of information to be preferentially displayed on the terminal when the means of transportation is a vehicle.

In the above information processing device, the control unit may be configured to determine the piece of information to be preferentially displayed on the terminal in such a manner that the piece of information to be preferentially displayed on the terminal does not include information on alcoholic beverages when the means of transportation is a vehicle.

An information processing method according to a second aspect of the present disclosure is an information processing method that is performed by a computer. The information processing method includes: acquiring a plurality of pieces of information related to a desired facility designated by a user; acquiring a means of transportation that is used by the user to move to the desired facility; and determining, based on the means of transportation, a piece of information to be preferentially displayed on a terminal associated with the user out of the pieces of information.

In the above information processing method, an order of priority in which the pieces of information are displayed on the terminal may be determined based on the means of transportation.

In the above information processing method, a piece of information to be displayed on the terminal may be selected from the pieces of information based on the means of transportation.

In the above information processing method, the means of transportation may be estimated based on information detected by a sensor provided in the terminal.

In the above information processing method, the means of transportation may be acquired based on information on the means of transportation entered by the user to the terminal.

In the above information processing method, the means of transportation may be estimated based on a location of the desired facility.

In the above information processing method, the means of transportation may be estimated based further on a travel history of the user.

In the above information processing method, when the means of transportation is a vehicle, information on a parking lot associated with the desired facility may be determined to be the piece of information to be preferentially displayed on the terminal.

In the above information processing method, when the means of transportation is a vehicle, the piece of information to be preferentially displayed on the terminal may be determined in such a manner that the piece of information to be preferentially displayed on the terminal does not include information on alcoholic beverages.

A non-transitory storage medium according to a third aspect of the present disclosure is a non-transitory storage medium storing a program that causes one or more processors of a computer to perform an information processing method. The information processing method includes: acquiring a plurality of pieces of information related to a desired facility designated by a user; acquiring a means of transportation that is used by the user to move to the desired facility; and determining, based on the means of transportation, a piece of information to be preferentially displayed on a terminal associated with the user out of the pieces of information.

In the above non-transitory storage medium, in the above information processing method, an order of priority in which the pieces of information are displayed on the terminal may be determined based on the means of transportation.

According to the present disclosure, information can be provided in a way that is more convenient to a user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an overview of a search system;

FIG. 2 is a block diagram schematically showing an example of functional configurations of a user terminal and a search server in a first embodiment;

FIG. 3 shows an example of a result screen;

FIG. 4 shows an example of a table configuration of facility information stored in a facility database;

FIG. 5 shows an example of a table configuration of priority level information stored in a priority level database;

FIG. 6 is a flowchart of a transmission process in the first embodiment;

FIG. 7 is a block diagram schematically showing an example of functional configurations of a user terminal and a search server in a second embodiment;

FIG. 8 shows an example of a table configuration of history information stored in a history database;

FIG. 9 is a block diagram schematically showing an example of functional configurations of a user terminal and a search server in a third embodiment;

FIG. 10 shows an example of a table configuration of selection information; and

FIG. 11 is a flowchart of a transmission process in the third embodiment.

### DETAILED DESCRIPTION OF EMBODIMENTS

The information processing device according to the first aspect of the present disclosure is an information processing device that provides information related to various facilities to a user. The control unit in the information processing device according to the first aspect of the present disclosure acquires a plurality of pieces of information related to a desired facility. The desired facility is a facility designated by the user.

Information related to the desired facility that is useful to the user may vary depending on the means of transportation that is used by the user to move to the desired facility. The control unit in the information processing device also acquires a means of transportation that is used by user to move to the desired facility. The control unit also determines, based on the means of transportation of the user, a piece of information to be preferentially displayed on a terminal out of the acquired pieces of information. The terminal is a terminal associated with the user.

As described above, the information processing device determines the piece of information to be preferentially displayed on the terminal, based on the means of transportation that is used by the user to move to the desired facility. Information that is useful to the user when the user moves to the desired facility can thus be preferentially displayed on the terminal. Accordingly, information can be provided in a way that is more convenient to the user.

Hereinafter, specific embodiments of the present disclosure will be described with reference to the drawings. The dimensions, materials, shapes, relative arrangements, etc. of components described in the embodiments are not intended to limit the technical scope of the present disclosure to those dimensions, materials, shapes, relative arrangements, etc. unless otherwise specified.

### First Embodiment

System Overview

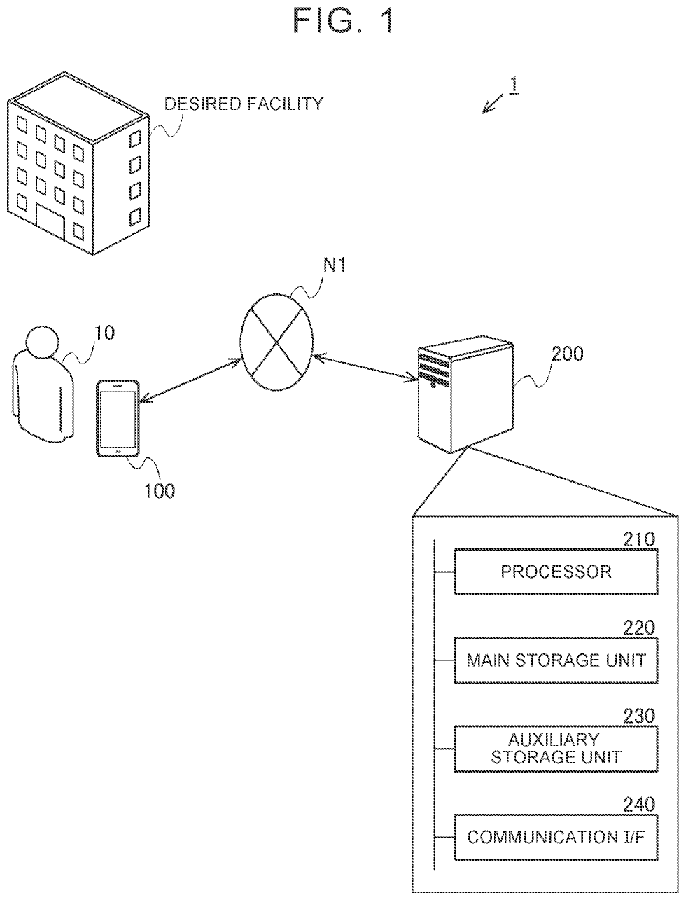

A search system 1 of the present embodiment will be described with reference to FIG. 1. FIG. 1 shows an overview of the search system 1. The search system 1 includes a user terminal 100 and a search server 200. In the search system 1, the user terminal 100 and the search server 200 are connected to each other via a network N1. For example, the network N1 may be a wide area network (WAN) that is a world-wide public communication network such as the Internet, or a telephone communication network for mobile phones etc.

User Terminal 100

The user terminal 100 is a terminal associated with a user 10. In the present embodiment, the user terminal 100 is a mobile information terminal carried by the user 10 such as smartphone, tablet computer, or wearable terminal. The user 10 moves toward a desired facility while carrying the user terminal 100. The user 10 searches for information on the desired facility using his or her user terminal 100 while moving toward the desired facility. The user terminal 100 in the present embodiment corresponds to the “terminal” according to the present disclosure.

### Search Server 200

The search server 200 is a server that provides information related to various facilities. The search server 200 provides information related to the desired facility searched by the user 10 to the user 10 moving toward the desired facility.

Information related to the desired facility that is useful to the user 10 may vary depending on the means of transportation used by the user 10. For example, when the current means of transportation of the user 10 is a vehicle, information on a parking lot associated with the desired facility may be the information useful to the user 10. The parking lot associated with the desired facility is a parking lot inside the desired facility or a parking lot outside the desired facility where users of the desired facility park their vehicles. When the current means of transportation of the user 10 is walking, information that introduces, for example, services provided at the desired facility (hereinafter simply referred to as the “information that introduces the desired facility”) rather than the information on a parking lot associated with the desired facility may be the information that is useful to the user 10. The search server 200 therefore reflects the current means of transportation of the user 10 in the information related to the desired facility (hereinafter sometimes referred to as the “desired information”) to be provided to the user 10. A method for reflecting the current means of transportation of the user 10 in the desired information to be provided by the search server 200 to the user 10 will be described later.

The search server 200 includes a computer having a processor 210, a main storage unit 220, an auxiliary storage unit 230, and a communication interface (communication I/F) 240. The processor 210 is, for example, a central processing unit (CPU) or a digital signal processor (DSP). The main storage unit 220 is, for example, a random access memory (RAM). The auxiliary storage unit 230 is, for example, a read-only memory (ROM). The auxiliary storage unit 230 is, for example, a hard disk drive (HDD) or a disc recording medium such as compact disc read-only memory (CD-ROM), digital versatile disc (DVD), or Blu-ray disc. The auxiliary storage unit 230 may be a removable medium (portable recording medium). Examples of the removable medium include a Universal Serial Bus (USB) memory or a Secure Digital (SD) card. The communication I/F 240 is, for example, a local area network (LAN) interface board or a wireless communication circuit for wireless communication.

The auxiliary storage unit 230 of the search server 200 stores an operating system (OS), various programs, various information tables, etc. The search server 200 can implement its various functions as will be described later by the processor 210 loading the programs stored in the auxiliary storage unit 230 into the main storage unit 220 and executing the programs. However, a part or all of the functions of the search server 200 may be implemented by a hardware circuit such as application-specific integrated circuit (ASIC) or field-programmable gate array (FPGA). The search server 200 need not necessarily be implemented by a single physical configuration, and may be configured by a plurality of computers that cooperates with each other. The search server 200 in the present embodiment corresponds to the “information processing device” according to the present disclosure.

Functional Configurations

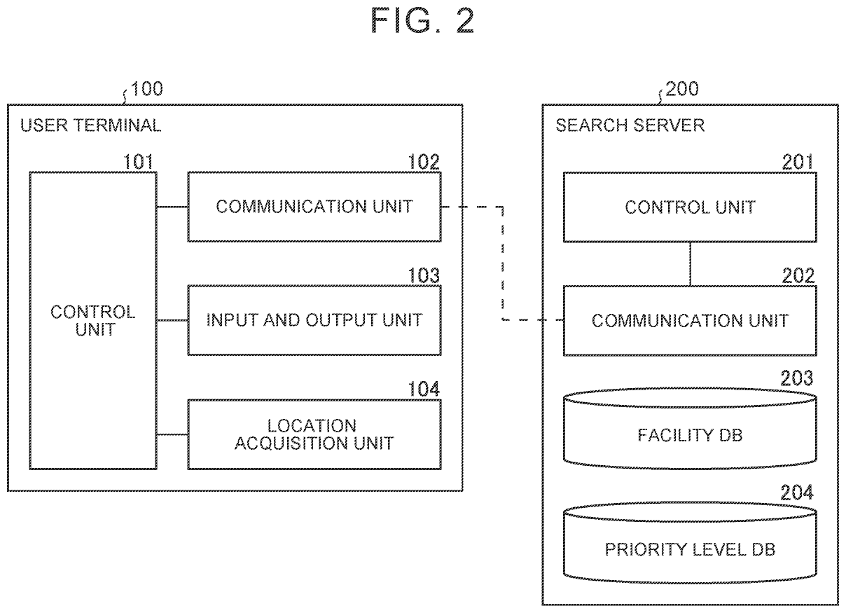

Next, the functional configurations of the user terminal 100 and the search server 200 that form the search system 1 according to the present embodiment will be described with reference to FIGS. 2 to 5. FIG. 2 is a block diagram schematically showing an example of the functional configurations of the user terminal 100 and the search server 200 of the present embodiment.

User Terminal 100

The user terminal 100 includes a control unit 101, a communication unit 102, an input and output unit 103, and a location acquisition unit 104. The control unit 101 has a function to perform arithmetic calculations for controlling the user terminal 100. The control unit 101 can be implemented by a processor in the user terminal 100. The communication unit 102 has a function to connect the user terminal 100 to the network N1. The communication unit 102 can be implemented by a communication I/F in the user terminal 100.

The input and output unit 103 has a function for the user 10 to enter various kinds of information to the user terminal 100. The input and output unit 103 further has a function to display various kinds of information to the user 10. The input and output unit 103 can be implemented by a touch panel in the user terminal 100. In order to search for information on the desired facility, the user 10 enters information identifying the desired facility (hereinafter sometimes referred to as the “specific information”) to the input and output unit 103. As used herein, the specific information is information including, for example, the name of the desired facility.

The location acquisition unit 104 has a function to acquire the current location of the user terminal 100. The location acquisition unit 104 can be implemented by a Global Positioning System (GPS) sensor in the user terminal 100. The control unit 101 detects the means of transportation of the moving user 10 based on the current location of the user terminal 100 (that is, the current location of the user 10) acquired by the location acquisition unit 104.

The control unit 101 detects the means of transportation of the user 10 based on, for example, the current location of the user 10. Specifically, the control unit 101 calculates the moving speed of the user 10 based on changes in current location of the user 10. The control unit 101 detects that the means of transportation of the user 10 is a vehicle when the current location of the user 10 is on a roadway and the average moving speed of the user 10 is equal to or greater than a predetermined value. The control unit 101 detects that the means of transportation of the user 10 is walking when the current location of the user 10 is on a sidewalk and the average moving speed of the user 10 is equal to or less than a predetermined value.

The means of transportation of the user 10 detected by the control unit 101 is not necessarily limited to a vehicle or walking. The user terminal 100 may detect, for example, a bicycle, a train, etc. as a means of transportation of the user 10. The control unit 101 can detect the means of transportation of the user 10 using a known method.

The control unit 101 generates information including the specific information and the acquired current means of transportation of the user 10 (hereinafter sometimes referred to as the “search information”). The control unit 101 sends the search information to the search server 200 via the communication unit 102.

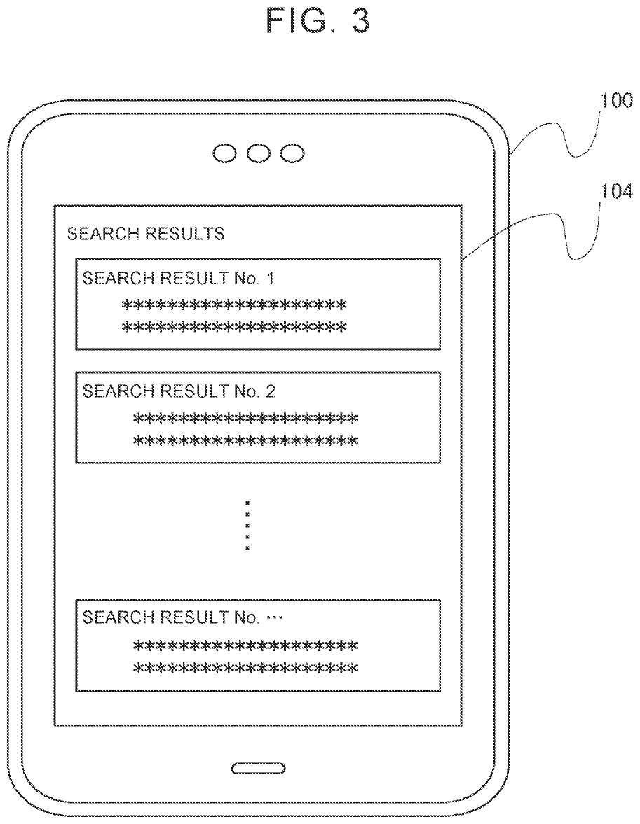

The control unit 101 receives result information from the search server 200 via the communication unit 102. The result information includes a plurality of pieces of desired information related to the desired facility. When the control unit 101 receives the result information via the communication unit 102, the control unit 101 causes the input and output unit 103 to display a result screen. FIG. 3 shows an example of the result screen. As shown in FIG. 3, a plurality of pieces of desired information included in the result information is displayed on the result screen based on the result information. The desired information included in the result information is information such as text, image, or video related to the desired facility.

As shown in FIG. 3, the pieces of desired information included in the result information are displayed from top to bottom on the result screen. In the present embodiment, the result information includes the order of priority in which the pieces of desired information are displayed on the result screen (hereinafter sometimes referred to as the “display order”). The control unit 101 displays the pieces of desired information included in the result information based on the display order. The control unit 101 displays the piece of desired information with the highest display order at the first position from the top of the result screen (the position of Search result No. 1). The control unit 101 displays the piece of desired information with the second highest display order at the second position from the top of the result screen (the position of Search result No. 2). In this way, the control unit 101 causes the input and output unit 103 to display the pieces of desired information in descending display order. The display order included in the result information will be described in detail later.

In the present embodiment, the user terminal 100 displays the pieces of desired information included in the result information from top to bottom according to the display order. However, the user terminal 100 need not necessarily display the pieces of desired information from top to bottom according to the display order. For example, the user terminal 100 may display the piece of desired information with the highest display order in the largest size on the result screen. In this case, the piece of desired information with the highest display order is displayed in a smaller size than the most useful information. The positions where the pieces of desired information are to be displayed on the result screen are determined in advance.

Search Server 200

The search server 200 includes a control unit 201, a communication unit 202, a facility database (facility DB) 203, and a priority level database (priority level DB) 204. The control unit 201 has a function to perform arithmetic calculations for controlling the search server 200. The control unit 201 can be implemented by the processor 210 in the search server 200. The communication unit 202 has a function to connect the search server 200 to the network N1. The communication unit 202 can be implemented by the communication I/F 240 in the search server 200.

The facility DB 203 is a database for storing facility information. The facility DB 203 can be implemented by the auxiliary storage unit 230 in the search server 200. The facility information is information related to facilities. The facility DB 203 also includes facility information of the desired facility (desired information).

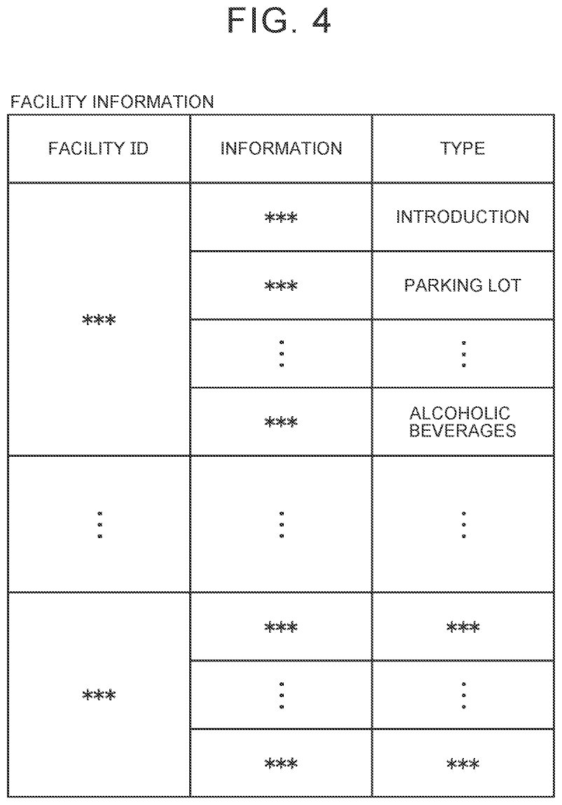

FIG. 4 shows an example of a table configuration of the facility information stored in the facility DB 203. As shown in FIG. 4, the facility information has a facility ID field, an information field, and a type field. Identifiers (facility IDs) identifying facilities are input to the facility ID field. Facility information related to each facility input to the facility ID field is input to the information field. The facility information that is input to the information field is, for example, information that introduces services provided at the facility (information that introduces the facility), information on a parking lot associated with the facility, or information on alcoholic beverages provided at the facility. Text, an image, a video, etc. is input as the facility information to the information field.

Types of facility information are input to the type field. When the facility information is information that introduces the facility, “introduction” is input to the type field. When the facility information is information on a parking lot associated with the facility, “parking lot” is input to the type field. When the facility information is information on alcoholic beverages provided at the facility, “alcoholic beverages” is input to the type field. The types of facility information that are input to the type field are input in advance by an administrator of the search server 200 based on the content of each piece of facility information. The type of each piece of facility information that is input to the type field may be input by, for example, analyzing the content of each piece of facility information by the search server 200.

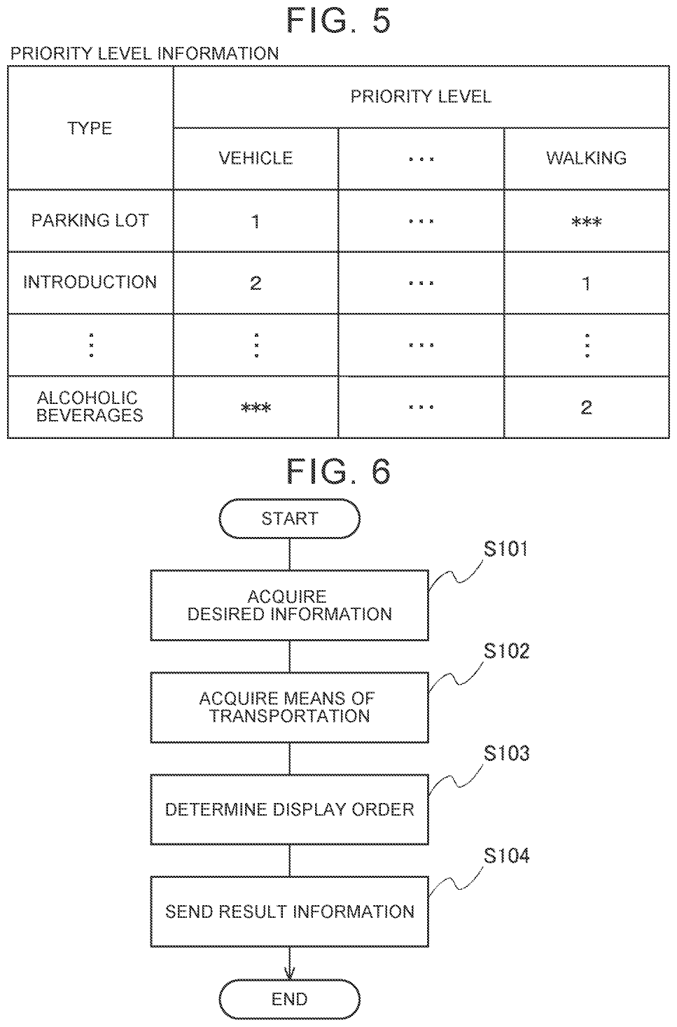

The priority level DB 204 is a database for storing priority level information. The priority level DB 204 can be implemented by the auxiliary storage unit 230 in the search server 200. The priority level information is information on the priority level that is used when the user terminal 100 displays a plurality of pieces of facility information (desired information). FIG. 5 shows an example of a table configuration of the priority level information stored in the priority level DB 204.

As shown in FIG. 5, the priority level information has a type field and a priority level field. All the types of facility information input to the type field in the facility information are input to the type field. The priority levels according to the means of transportation are input to the priority level field. The priority levels are determined so that the more useful the type (content) of facility information is to the user who is moving by each means of transportation, the higher the priority level. The priority levels are set in advance by, for example, the user 10 or the administrator of the search server 200.

In the present embodiment, the type of facility information that is most useful when the means of transportation is a vehicle is a parking lot associated with the facility. Therefore, information on a parking lot associated with the facility is set to the highest priority level for when the means of transportation is a vehicle. The type of facility information that is second most useful when the means of transportation is a vehicle is introduction of services etc. provided at the facility. Therefore, information that introduces the facility is set to the second highest priority level for when the means of transportation is a vehicle. The type of facility information that is the least useful when the means of transportation is a vehicle is alcoholic beverages provided at the facility. Therefore, information on alcoholic beverages is set to the lowest priority level for when the means of transportation is a vehicle.

Priority levels that are different from those set for when the means of transportation is a vehicle are set for when the means of transportation is not a vehicle. In the present embodiment, information that introduces the facility is set to the highest priority level for when the means of transportation is walking. Information on alcoholic beverages is set to the second highest priority level for when the means of transportation is walking. Information on a parking lot associated with the facility is set to the lowest priority level for when the means of transportation is walking.

The control unit 201 acquires a plurality of pieces of desired information (facility information on the desired facility) from the facility DB 203 based on the specific information included in the search information. The control unit 201 also acquires the current means of transportation of the user 10 included in the search information. The control unit 201 also acquires the priority level information from the priority level DB 204. The control unit 201 then determines the display order of the pieces of desired information based on the correspondence between the type of facility information and the priority level in the priority level information and the current means of transportation of the user 10.

Specifically, the control unit 201 acquires the type of each piece of desired information from the facility DB 203. The control unit 201 then determines the display order of the pieces of desired information in descending order of priority level corresponding to the type of desired information, based on the current means of transportation of the user 10. That is, the display order of the pieces of desired information is determined in descending order of usefulness to the user 10 who is moving by the means of transportation included in the search information. When the means of transportation of the user 10 is a vehicle, the display order is determined so that information on a parking lot associated with the desired facility has the highest display order, followed by information that introduces the desired facility and information on alcoholic beverages. The control unit 201 generates result information including the pieces of desired information and their display order. The control unit 201 sends the result information to the user terminal 100 via the communication unit 202.

There are cases where the types of two or more of the pieces of desired information are the same. In this case, the control unit 201 determines, for example, the display order of the desired information rated higher to be higher than the display order of the desired information rated lower. The ratings of the desired information are, for example, the ratings on the usefulness of the desired information given by the users who have been provided with the desired information from the search server 200 in the past.

Transmission Process

Next, a transmission process that is performed by the control unit 201 of the search server 200 in the search system 1 according to the present embodiment will be described with reference to FIG. 6. FIG. 6 is a flowchart of the transmission process in the present embodiment. The transmission process is a process of sending result information to the user 10. The transmission process is started when the search server 200 receives search information from the user terminal 100.

In the transmission process, a plurality of pieces of desired information is first acquired based on the search information in S101. The current means of transportation of the user 10 included in the search information is then acquired in S102. Next, in S103, the display order of the pieces of desired information is determined based on the current means of transportation of the user 10 and the priority level information. Thereafter, in S104, result information including the pieces of desired information and their display order is generated and sent to the user terminal 100. The transmission process is thus ended.

When the user terminal 100 receives the result information, the user terminal 100 displays the result screen. When the means of transportation of the user 10 is a vehicle, the display order is determined so that information on a parking lot associated with the desired facility has the highest display order, followed by information that introduces the desired facility and information on alcoholic beverages. Accordingly, of the pieces of desired information, the information on a parking lot associated with the desired facility is preferentially displayed on the user terminal 100. The information on alcoholic beverage is not preferentially displayed on the user terminal 100 as this information has the lowest display order.

As described above, the search system 1 determines the display order of the pieces of desired information to be displayed on the user terminal 100, based on the means of transportation of the user 10 to the desired facility. Accordingly, of the pieces of desired information, the piece of desired information with the highest display order is preferentially displayed on the user terminal 100. The user terminal 100 can thus display the desired information that is useful to the user 10 who is moving toward the desired facility. Accordingly, the desired information can be provided in a way that is more convenient to the user 10.

### First Modification

In the embodiment, the user 10 searches for information on a desired facility while moving toward the desired facility. The user terminal 100 then detects the means of transportation of the user 10 based on the detection value from a sensor (GPS sensor, acceleration sensor, etc.) in the user terminal 100. However, the user terminal 100 need not necessarily detect the means of transportation of the user 10 based on the detection value from the sensor in the user terminal 100. In this modification, when the user 10 searches for information on a desired facility, the user 10 enters information on the means of transportation to the desired facility to the user terminal 100. The user terminal 100 sends search information including the means of transportation entered by the user 10 to the search server 200. The search server 200 determines the display order of a plurality of pieces of desired information based on the information on the means of transportation entered by the user 10. Even in this case, the desired information can be provided in a way that is more convenient to the user 10.

In this modification, the user terminal 100 can find out the means of transportation of the user 10 without using the detection value obtained by the sensor in the user terminal 100 as the user 10 moves toward the desired facility. The user 10 can therefore search for information on the desired facility even when the user 10 is not moving toward the desired facility. Accordingly, the user terminal 100 need not necessarily be a mobile information terminal that is carried by and moved with the user 10. In this case, the user terminal 100 may be, for example, a computer that is used by the user 10 at home etc.

### Second Modification

In the embodiment, the user terminal 100 detects the means of transportation of the user 10 and sends the detected means of transportation to the search server 200. However, the means of transportation of the user 10 need not necessarily be detected by the user terminal 100. For example, the user terminal 100 sends the current location of the user 10 in real time to the search server 200. The search server 200 may then detect the means of transportation of the moving user 10 based on the current location of the user 10 received from the user terminal 100. Since the method in which the search server 200 detects the means of transportation of the moving user 10 based on the current location of the user 10 is similar to the method described above, description thereof will be omitted.

### Third Modification

In the embodiment, the search server 200 determines the display order of a plurality of pieces of desired information based on the means of transportation of the user 10. In this modification, however, the user terminal 100 determines the display order of a plurality of pieces of desired information based on the means of transportation of the user 10. Specifically, the user terminal 100 acquires a plurality of pieces of desired information from the search server 200. The user terminal 100 also acquires the current means of transportation of the user 10. In this modification, an auxiliary storage unit in the user terminal 100 stores priority level information in advance. That is, the user terminal 100 includes a priority level DB. The user terminal 100 acquires priority level information from the priority level DB in the user terminal 100. The user terminal 100 then determines the display order of the pieces of desired information based on the acquired priority level information.

### Second Embodiment

In the present embodiment, the search server 200 acquires the means of transportation of the user 10 by estimating the means of transportation of the user 10 based on the location of a desired facility. Only the differences from the first embodiment will be described below.

Functional Configurations

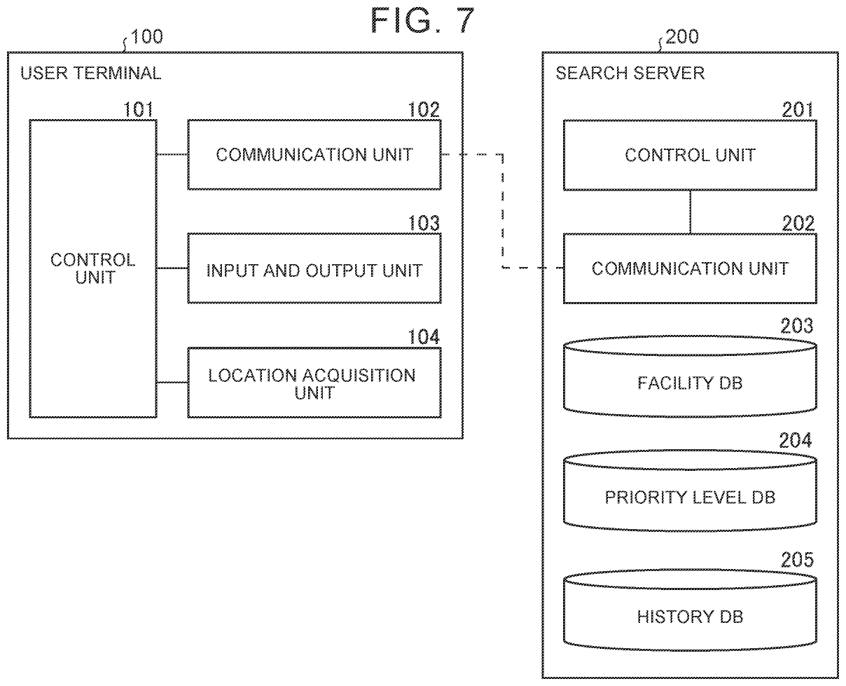

FIG. 7 is a block diagram schematically showing an example of the functional configurations of the user terminal 100 and the search server 200 of the present embodiment. As shown in FIG. 7, the search server 200 further includes a history database (history DB) 205.

User Terminal 100

The control unit 101 in the user terminal 100 sends the current location of the user 10 in real time to the search server 200 via the communication unit 102. The control unit 101 also generates search information including specific information and sends the generated search information to the search server 200. In the present embodiment, the user 10 searches for information on a desired facility even when the user 10 is not moving toward the desired facility.

Search Server 200

The control unit 201 receives the current location of the user 10 in real time via the communication unit 202. The control unit 201 identifies a destination area of the user 10 based on changes in current location of the user 10. Specifically, when the current location of the user 10 has been in a specific area for a predetermined time or longer, the control unit 201 determines that the specific area is the destination area of the user 10. The control unit 201 also detects the means of transportation used by the user 10 to move to the destination area, based on the changes in current location of the user 10. Since the method in which the search server 200 detects the means of transportation of the user 10 to the destination area based on the changes in current location of the user 10 is similar to the method described above, description thereof will be omitted. The control unit 201 then stores the destination area of the user 10 and the means of transportation of the user 10 in association with each other in the history DB 205 as history information. That is, the history information is information on the travel history of the user 10.

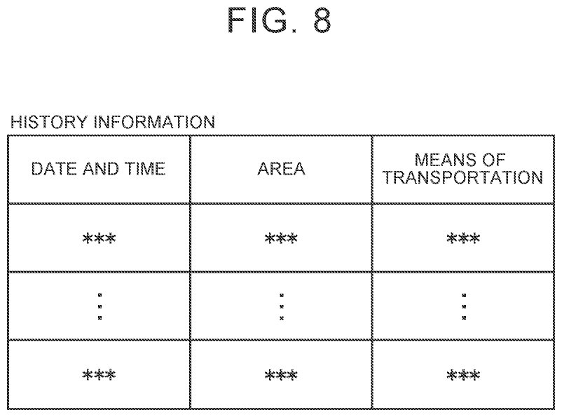

The history DB 205 is a database storing history information. The history DB 205 can be implemented by the facility DB 203 in the search server 200. FIG. 8 shows an example of a table configuration of the history information stored in the history DB 205. As shown in FIG. 8, the history information has a date and time field, an area field, and a means of transportation field. Dates and times the user 10 moved to each destination area are input to the date and time field. Destination areas of the user 10 are input to the area field. Means of transportation used by the user 10 to move to each destination area are input to the means of transportation field.

The control unit 201 receives the search information from the user terminal 100 via the communication unit 202. The control unit 201 estimates the means of transportation of the user 10 to the desired facility based on the location of the desired facility and the history information. Specifically, the control unit 201 identifies the location of the desired facility based on the search information and identifies the area including the desired facility (hereinafter sometimes referred to as the “desired area”). The control unit 201 estimates, based on the history information stored in the history DB 205, that the means of transportation the user 10 used in the past to move to the desired area is the means of transportation of the user 10 to the desired facility. There are cases where the history information includes a plurality of means of transportation of the user 10 to the desired area. In this case, the control unit 201 estimates that the means of transportation that is highest in number in the history information out of the plurality of means of transportation used by the user 10 in the past to move to the desired area is the means of transportation of the user 10 to the desired facility.

As described above, the search system 1 estimates the means of transportation of the user 10 based on the location of the desired facility and the history information. The display order of a plurality of pieces of desired information is determined based on the estimated means of transportation of the user 10 to the desired facility. Even in this case, the desired information can be provided in a way that is more convenient to the user 10.

### Modification

In the embodiment, the means of transportation of the user 10 is estimated based on the location of a desired facility and the travel history of the user 10. However, the means of transportation of the user 10 need not necessarily be estimated based on the travel history of the user 10. For example, the search server 200 may acquire the location of a desired facility and determine the means of transportation of the user 10 based on the distance between the desired facility and the train station nearest to the desired facility. In this case, the search server 200 estimates that the means of transportation of the user 10 is a vehicle when the distance between the desired facility and the train station nearest to the desired facility is equal to or greater than a predetermined distance. Even in this way, the search server 200 can find out the means of transportation of the user 10 based on the location of the desired facility.

### Third Embodiment

In the first embodiment, the search server 200 sends result information including a plurality of pieces of desired information and their display order to the user terminal 100. In the present embodiment, however, the search server 200 selects a piece of desired information to be displayed on the user terminal 100 from a plurality of pieces of desired information. Only the differences from the first embodiment will be described below.

Functional Configurations

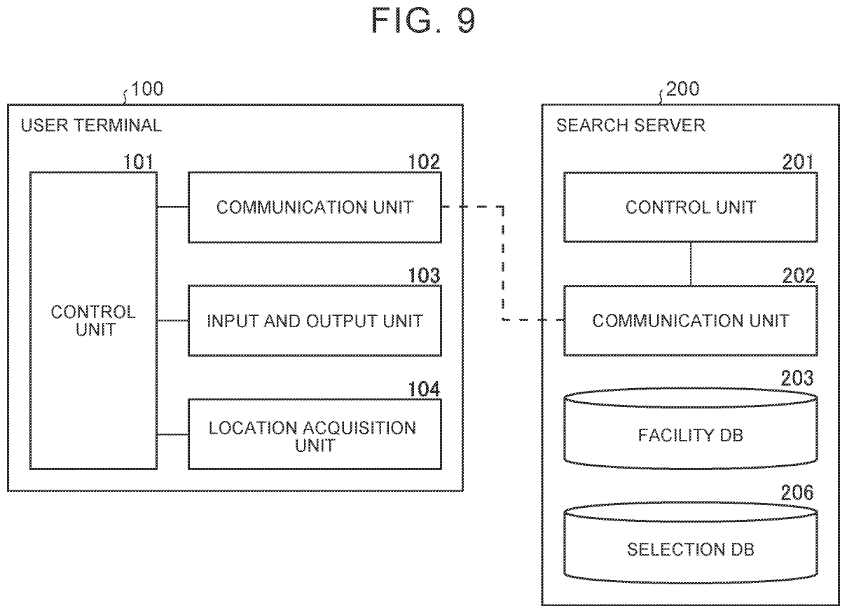

FIG. 9 is a block diagram schematically showing an example of the functional configurations of the user terminal 100 and the search server 200 of the present embodiment. As shown in FIG. 9, the search server 200 includes a selection database (selection DB) 206 instead of the priority level DB 204. The selection DB 206 can be implemented by the auxiliary storage unit 230 in the search server 200.

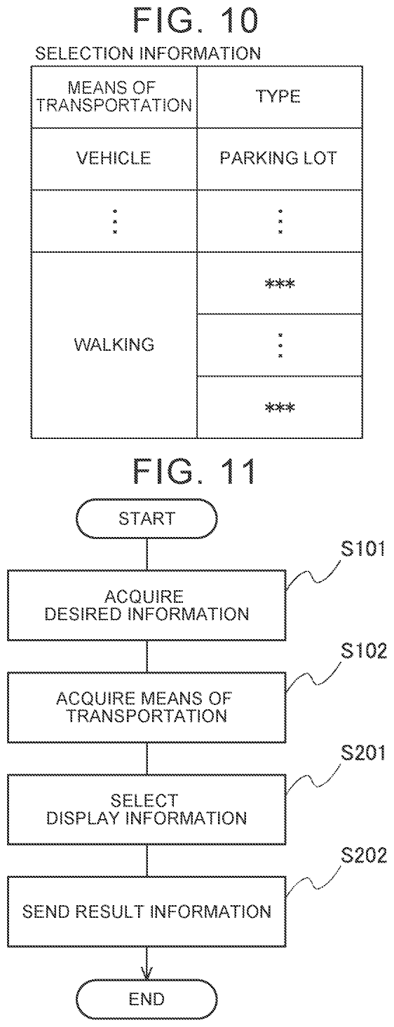

The selection DB 206 is a database storing selection information. The selection information is information for the control unit 201 to select a piece of facility information (desired information) that is useful to the user. FIG. 10 shows an example of a table configuration of the selection information. As shown in FIG. 10, the selection information has a means of transportation field and a type field. Means of transportation that are used by the user to move are input to the means of transportation field. Types of facility information that are provided to the user who moves by the means of transportation input to the means of transportation field are input to the type field. When the user moves by a vehicle, information on a parking lot associated with the facility is information useful to the user. Accordingly, “parking lot” is input to the type field corresponding to the means of transportation field where a vehicle is input. In the type field, a plurality of types of facility information may be input for a single means of transportation. When the user moves by a vehicle, information on alcoholic beverages provided at the facility is not information useful to the user. Accordingly, “alcoholic beverages” is not input to the type field corresponding to the means of transportation field where a vehicle is input.

The control unit 201 acquires a plurality of pieces of desired information from the facility DB 203. The control unit 201 also acquires the current means of transportation of the user 10. The control unit 201 also acquires the selection information from the selection DB 206. The control unit 201 then selects a piece of display information to be displayed on the user terminal 100 from the pieces of desired information based on the current means of transportation of the user 10 and the selection information.

Specifically, the control unit 201 acquires the type of facility information corresponding to the current means of transportation of the user 10 from the selection information. The control unit 201 then selects from the acquired pieces of desired information a piece of desired information whose type matches the type of facility information acquired from the selection information as the display information. For example, the control unit 201 acquires “parking lot” from the selection information when the current means of transportation of the user 10 is a vehicle. The control unit 201 then selects from the pieces of desired information a piece of information whose type is “parking lot” as the display information. In this way, the control unit 201 selects a piece of display information from the pieces of desired information. The control unit 201 sends result information including the selected piece of display information to the user terminal 100 via the communication unit 202. The control unit 201 may select two or more pieces of desired information of the same type from the pieces of desired information.

Transmission Process

Next, a transmission process that is performed by the control unit 201 of the search server 200 in the search system 1 according to the present embodiment will be described with reference to FIG. 11. FIG. 11 is a flowchart of the transmission process in the present embodiment. S101 and S102 of the transmission process according to the present embodiment are similar to S101 and S102 of the transmission process according to the first embodiment.

In the transmission process, S101 and S102 are first performed. Next, in S201, a piece of display information is selected from a plurality of pieces of desired information based on the current means of transportation of the user 10 and the selection information. Then, in S202, result information including the selected piece of display information is generated and sent to the user terminal 100. The transmission process is thus ended.

The user terminal 100 that has received the result information displays the piece of display information included in the result information on the result screen. At this time, when the means of transportation of the user 10 is a vehicle, information on a parking lot associated with the desired facility is preferentially displayed on the user terminal 100. When the means of transportation of the user 10 is a vehicle, information on alcoholic beverages is not selected as the display information and therefore is not displayed on the user terminal 100.

As described above, the search system 1 selects a piece of display information from the pieces of desired information based on the means of transportation of the user 10 to the desired facility. The search system 1 thus determines a piece of display information to be preferentially displayed on the user terminal 100 out of the pieces of desired information. As a result, the search system 1 can cause the user terminal 100 to display the desired information (display information) that is useful to the user 10 who is moving toward the desired facility. Accordingly, the desired information can be provided in a way that is move convenient to the user 10.

### Modification

When result information includes a plurality of pieces of display information, the result information may include the display order of the pieces of display information. In this case, the search server 200 includes the facility DB 203, the priority level DB 204, and the selection DB 206. The search server 200 determines the display order of the pieces of display information based on the correspondence between the type of facility information and the priority level in the priority level information stored in the priority level DB 204. The search server 200 then sends result information including the pieces of display information and their display order to the user terminal 100. Even in this case, desired information can be provided in a way that is more convenient to the user 10.

### Other Embodiments

The above embodiments are by way of example only, and the present disclosure may be modified as appropriate without departing from the spirit and scope of the present disclosure. For example, the processes and means described in the present disclosure can be combined as desired as long as no technical contradiction occurs.

The processes described as being performed by one device may be allocated to and performed by a plurality of devices. Alternatively, the processes described as being performed by different devices may be performed by one device. The type of hardware configuration (server configuration) that is used to implement each function in the computer system can be flexibly changed.

The present disclosure can also be implemented by supplying a non-transitory storage medium storing computer programs implementing the functions described in the above embodiments to a computer, and causing one or more processors of the computer to read and execute the programs. Such computer programs may be provided to the computer by a non-transitory computer-readable storage medium that can be connected to a system bus of the computer, or may be provided to the computer via a network. Examples of the non-transitory computer-readable storage medium include: any type of disk or disc such as magnetic disk (floppy (registered trademark) disk, hard disk drive (HDD), etc.) and optical disc (CD-ROM, DVD, Blu-ray disc, etc.); a read-only memory (ROM); a random access memory (RAM); an erasable programmable read-only memory (EPROM); an electrically erasable programmable read-only memory (EEPROM); a magnetic card; a flash memory; an optical card; and any type of medium suitable for storing electronic instructions.

What is claimed is:

1. An information processing device, comprising a control unit configured to execute:
acquiring a plurality of pieces of information related to a desired facility designated by a user;
acquiring a means of transportation that is used by the user to move to the desired facility; and
determining, based on the means of transportation, a piece of information to be preferentially displayed on a terminal associated with the user out of the pieces of information.

2. The information processing device according to claim 1, wherein the control unit is configured to determine, based on the means of transportation, an order of priority in which the pieces of information are displayed on the terminal.

3. The information processing device according to claim 1, wherein the control unit is configured to select a piece of information to be displayed on the terminal from the pieces of information based on the means of transportation.

4. The information processing device according to claim 1, wherein the control unit is configured to estimate the means of transportation based on information detected by a sensor provided in the terminal.

5. The information processing device according to claim 1, wherein the control unit is configured to acquire the means of transportation based on information on the means of transportation entered by the user to the terminal.

6. The information processing device according to claim 1, wherein the control unit is configured to estimate the means of transportation based on a location of the desired facility.

7. The information processing device according to claim 6, wherein the control unit is configured to estimate the means of transportation based further on a travel history of the user.

8. The information processing device according to claim 1, wherein the control unit is configured to determine information on a parking lot associated with the desired facility to be the piece of information to be preferentially displayed on the terminal when the means of transportation is a vehicle.

9. The information processing device according to claim 1, wherein the control unit is configured to determine the piece of information to be preferentially displayed on the terminal in such a manner that the piece of information to be preferentially displayed on the terminal does not include information on alcoholic beverages when the means of transportation is a vehicle.

10. An information processing method that is performed by a computer, the information processing method comprising:
acquiring a plurality of pieces of information related to a desired facility designated by a user;
acquiring a means of transportation that is used by the user to move to the desired facility; and
determining, based on the means of transportation, a piece of information to be preferentially displayed on a terminal associated with the user out of the pieces of information.

11. The information processing method according to claim 10, wherein an order of priority in which the pieces of information are displayed on the terminal is determined based on the means of transportation.

12. The information processing method according to claim 10, wherein a piece of information to be displayed on the terminal is selected from the pieces of information based on the means of transportation.

13. The information processing method according to claim 10, wherein the means of transportation is estimated based on information detected by a sensor provided in the terminal.

14. The information processing method according to claim 10, wherein the means of transportation is acquired based on information on the means of transportation entered by the user to the terminal.

15. The information processing method according to claim 10, wherein the means of transportation is estimated based on a location of the desired facility.

16. The information processing method according to claim 15, wherein the means of transportation is estimated based further on a travel history of the user.

17. The information processing method according to claim 10, wherein when the means of transportation is a vehicle, information on a parking lot associated with the desired facility is determined to be the piece of information to be preferentially displayed on the terminal.

18. The information processing method according to claim 10, wherein when the means of transportation is a vehicle, the piece of information to be preferentially displayed on the terminal is determined in such a manner that the piece of information to be preferentially displayed on the terminal does not include information on alcoholic beverages.

19. A non-transitory storage medium storing a program that causes one or more processors of a computer to perform an information processing method, wherein the information processing method comprises:
acquiring a plurality of pieces of information related to a desired facility designated by a user;
acquiring a means of transportation that is used by the user to move to the desired facility; and
determining, based on the means of transportation, a piece of information to be preferentially displayed on a terminal associated with the user out of the pieces of information.

20. The non-transitory storage medium according to claim 19, wherein in the information processing method, an order of priority in which the pieces of information are displayed on the terminal is determined based on the means of transportation.
